(19) United States
(12) Patent Application Publication
(10) Pub. No.: US 2026/0127166 A1
(43) Pub. Date: May 7, 2026

(54) VideoRAG using Natural Language as Intermediate Representation in Multi-Camera, Closed-Domain Applications

(71) Applicants: Faria Azim, Mountain House, CA (US); Ikra Iftekhar Shuvo, Cambridge, MA (US)

(72) Inventors: Faria Azim, Mountain House, CA (US); Ikra Iftekhar Shuvo, Cambridge, MA (US)

(73) Assignee: Shobdo, LLC, Mountain House, CA (US)

(21) Appl. No.: 19/435,377

(22) Filed: Dec. 29, 2025

(51) Int. Cl. G06F 16/242; G06F 16/22; G06F 16/2457; G06F 16/248; G06V 20/40; G08B 21/02

(52) U.S. Cl. CPC G06F 16/243; G06F 16/2246; G06F 16/24578; G06F 16/248; G06V 20/44; G08B 21/02

(57) ABSTRACT

A Video Retrieval Augmented Generation (VideoRAG) system for closed-domain applications that uses natural language text as an intermediate representation between video content and query systems. A unified vision-language model (VLM) processes video frames and generates structured JSON text descriptions conforming to domain-specific event schemas, while simultaneously answering natural language queries through retrieval-augmented generation. The natural language intermediate representation provides substantial storage efficiency improvements over embedding-based approaches, human-interpretable analytics capabilities, and cross-camera entity tracking. The architecture supports a closed-domain applications including but not limited to retail analytics, healthcare monitoring, and industrial safety operations.

### FIELD OF INVENTION

The present invention relates to video content analysis and retrieval systems, more particularly to a technical architecture employing natural language text (not embeddings) as an intermediate representation layer between video content and retrieval-augmented generation systems for closed-domain VideoRAG applications.

### BACKGROUND

### Definitions

Video-RAG addresses correctly responding to natural language queries regarding online videos (continuously streamed from cameras) or offline videos (stored). For example, “What did the person in the blue jacket do in the electronics aisle between 2 and 3 PM?” with responses including timestamps and video segment references.

Closed-Domain Applications refer to VideoRAG systems for predetermined application areas rather than general-purpose analysis. The scope of relevant events is known beforehand-customer behaviors in retail, patient activities in healthcare, safety compliance in industrial settings-rather than arbitrary video content analysis.

### Related Prior Art

### Video-RAG Systems and Embedding-Based Approaches

Retrieval-Augmented Generation (RAG) retrieves relevant text from a knowledge base to generate accurate, grounded natural language responses. RAG systems have been extended to video through various approaches. The predominant architecture, as disclosed in U.S. Ser. No. 11/954,151B1 (Coram A I, 2024), employs joint embedding spaces where video content and natural language queries convert to dense vectors for similarity matching using CLIP-style architectures. This processes video frames through vision encoders generating fixed-dimensional embeddings (typically 512 or 768 dimensions), stores these in vector databases, and performs cosine similarity matching against query embeddings. While embedding-based systems achieve semantic understanding, they present fundamental technical limitations for long-duration VideoRAG:
1. Storage Scaling for Intermediate Representations: Embedding-based systems suffer from a fundamental architectural limitation. Vector embeddings are generated for video frames regardless of content significance. This means the searchable index grows proportionally with video frame count, not event count. Embeddings are generated and stored continuously even during inactivity, such as overnight hours when retail stores are closed or hallways with no foot traffic. This disproportionately large number of vector embeddings causes significant storage and retrieval challenges. In contrast, natural language intermediate representations are event-driven: searchable descriptions stored only when significant events are detected (person enters, picks up product, completes transaction). Since VideoRAG typically applies where videos contain long inactivity periods interspersed with brief relevant activity, event-based representation storage fundamentally scales better than frame-based embedding storage for closed-domain applications.
2. Loss of Human-Explainability: Dense vector representations lack human-readable semantics. When retrieval systems return video segments based on embedding similarity scores (e.g., cosine similarity>0.85), operators cannot inspect the intermediate representation to understand why matches occurred or verify correctness without reviewing video footage.
3. Fine-Grained Detail Capture: Embedding requires compression, inherently losing frame-level details. Applications requiring precise temporal tracking (e.g., “person picked up item at 14:23:47, held for 12 seconds, returned to shelf at 14:23:59”) cannot reliably extract such information from fixed-length vector representations. US patent US20250181641A1 (NEC Laboratories America Inc., 2025) discloses a two-stage incremental system where lightweight models generate text descriptions converted to embeddings for indexing, followed by selective heavyweight model processing at query time. It maintains vector embeddings rather than human-readable text logs and lacks persistent entity tracking across cameras. Chinese patent CN120656102A discloses multimodal vector systems using dual-tower retrieval frameworks with dense embeddings from visual, audio, and ASR text modalities. CN120316308B employs sparse vector representations using dictionary learning (K-SVD) and orthogonal matching pursuit (OMP) algorithms. While sparse representations reduce storage through mathematical sparsity, they remain fundamentally vectorial and lack linguistic interpretability and fine-grained detail.

### Text-Based Video Indexing Prior Art

Early text-based video indexing, as disclosed in expired U.S. Pat. No. 5,835,667A (Carnegie Mellon, 1996), used speech transcription to create indexed text transcripts for video search. More recent U.S. Ser. No. 10/999,566B1 (Amazon, 2021) covers neural network generation of textual descriptions from video segments. However, these text-based indexing systems differ architecturally from the present invention in critical ways:
1. Comprehensive vs. Selective Event Capture: Prior art describes all video content comprehensively, wasting computational resources on non-events (empty scenes, background motion, domain-irrelevant activities). Closed-domain VideoRAG exploits domain knowledge to selectively capture only meaningful events. Selective capture achieves order-of-magnitude efficiency improvements in typical monitoring scenarios where relevant events are rare and may comprise less than 10% of total video duration.
2. Generic vs. Structured Attribute Schemas: Prior art generates free-form captions optimized for human readability but lacking structured attribute schemas enabling programmatic retrieval and analytics. VideoRAG often requires structured attributes (height categories, standardized color taxonomies, precise timestamps, spatial locations) to support attribute-based queries, statistical aggregation, and cross-camera correlation. Generic captions cannot reliably support such queries because attributes are expressed in unstructured natural language with high variability, preventing consistent matching and aggregation.
3. No Cross-Camera Entity Tracking: Prior art does not maintain entity identity across multiple descriptions or camera views, describing each segment independently. This makes temporal entity tracking queries infeasible, such as reconstructing a customer's journey across multiple camera views or tracking a patient's movements throughout a facility. Without entity correlation mechanisms, prior art cannot support queries requiring trail reconstruction or cross-camera analytics.
4. No Retrieval-Augmented Generation Architecture: Prior art systems provide text-based indexing and search but lack the generation component essential to VideoRAG. They do not employ language models to process natural language queries, retrieve relevant descriptions, and generate contextual responses grounded in retrieved events. This absence of query-driven generation fundamentally distinguishes these indexing systems from VideoRAG architectures.

### Cross-Camera Entity Tracking Prior Art

Multiple patents address cross-camera person re-identification and tracking. U.S. Pat. No. 9,134,399B2 discloses attribute-based person tracking across multiple cameras using soft-biometric features (clothing color, height) to match individuals across go non-overlapping camera fields of view. U.S. Ser. No. 10/579,880B2 describes real-time object re-identification employing edge computing architecture with frequency-domain similarity measures calculated via discrete Fourier transforms. US20230075888A1 and WO2021137763A1 cover object re-identification using feature space mapping with projection matrices and common dictionaries. Chinese patents CN104094279A and CN110706259A employ color histogram features and spatial constraints respectively for cross-camera visual target re-identification.

While these systems achieve cross-camera correlation, they fundamentally differ from the present invention: (1) they perform frame-level or clip-level re-identification without maintaining persistent entity trail logs tracking complete entity journeys from entry to exit across extended time periods, (2) their correlation outputs are numerical similarity scores or binary match decisions rather than structured natural language descriptions with temporal segments and activity descriptions, and (3) they lack natural language query interfaces for retrieval-augmented generation, operating instead as pure computer vision pipelines without integration into conversational AI systems.

### Video Event and Anomaly Detection Prior Art

Prior art in video analytics focuses on automated event and anomaly detection. U.S. Pat. No. 8,564,661B2 discloses rule-based video analytic systems, U.S. Pat. No. 8,866,910B1 covers unusual event detection based on moving object trajectories using Markov modeling, and US20080018738A1 addresses video analytics for retail business process monitoring including traffic flow and dwell time measurement. US20200364468A1 describes intelligent video surveillance using deep learning for weapon detection. WO2011022276A2 and AU2021218192B1 cover anomaly detection methodologies using adaptive voting experts and generative adversarial networks respectively.

These systems excel at detection and classification of predefined event types but architecturally differ from the present invention: (1) they output alerts, classifications, or statistical metrics rather than maintaining human-readable natural language event logs suitable for text-based retrieval, (2) they lack RAG-based query processing capabilities-users cannot ask natural language questions and receive generated responses with citations to specific detected events, and (3) their representations are optimized for machine decision-making (confidence scores, bounding boxes, trajectory parameters) rather than linguistic descriptions enabling semantic search and conversational interaction.

### General RAG Systems Prior Art

US20240346256A1 (Microsoft, 2024) discloses response generation using retrieval augmented AI models, representing state of the art in general-purpose RAG architectures. This system retrieves relevant information from knowledge bases and uses large language models to generate contextually grounded responses. However, it addresses text and static image retrieval rather than video content, lacking the dual-layer logging architecture (sensory logs+entity trail logs) specific to video surveillance domains, the clip-based temporal segmentation with delayed indexing for entity trail stabilization, and the domain-specific event schemas with selective capture mechanisms that exploit closed-domain characteristics.

### Academic Prior Art: ViTA and LAVAD

Recent academic work presents directly relevant prior art:
ViTA (CVPR 2024, NEC Labs) implements a video-to-text-to-RAG pipeline for surveillance: processes video frames, generates timestamped text descriptions, stores in vector database for semantic search, achieving 43% latency reduction for 24-hour surveillance analysis.
LAVAD (CVPR 2024) uses vision-language model (VLM) frame captioning followed by large language model (LLM) temporal aggregation for anomaly detection.
Luo et al. (NeurIPS 2025) presents a training-free Video-RAG pipeline using OCR, ASR, and object detection to generate auxiliary texts on-demand when queries arrive. This query-driven approach retrieves relevant information temporarily via FAISS similarity search to answer specific questions, then discards it-contrasting with the present invention's persistent dual-layer logging architecture.

Critical technical distinctions exist between these academic systems and the present invention:
1. Persistent vs. Temporary Storage: Luo et al. generates auxiliary texts on-demand for query answering and discards them after use, while ViTA and US20250181641A1 convert text descriptions to embeddings for retrieval. The present invention maintains persistent dual-layer text-based logs (sensory logs+entity trail logs) with B-tree indexing for direct text-based retrieval and long-term analytics.
2. Generic vs. Domain-Specific Schemas: Luo et al. and US20250181641A1 use generic OCR/ASR/object detection without structured domain knowledge. The present invention employs configurable domain-specific event schemas with defined attribute taxonomies and selective capture mechanisms that exploit closed-domain characteristics.
3. Query-Driven vs. Continuous Processing: Luo et al. generates auxiliary information only when queries arrive, US20250181641A1 processes all clips with lightweight models upfront then applies heavyweight models at query time. The present invention employs event-driven continuous processing that generates structured representations only for detected significant events, fundamentally reducing index size while enabling temporal pattern analysis.
4. No Cross-Camera Entity Tracking: Neither Luo et al., ViTA, US20250181641A1, nor LAVAD implements persistent entity identification across camera views or extended time periods, which the present invention achieves through algorithmic correlation of textual attribute descriptions in the entity trail logs.

### REFERENCES CITED

### U.S. Patent Documents

US20250181641A1—Jun. 5, 2025—Retrieval augmented generation for videos (NEC Laboratories America Inc.)
US20240346256A1—Oct. 17, 2024—Response generation using a retrieval augmented AI model (Microsoft Technology Licensing LLC)
U.S. Ser. No. 11/954,151B1—Apr. 9, 2024—Natural language processing for searching security video data (Coram AI, Inc.)
US20230075888A1—Mar. 9, 2023—Object re-identification using multiple cameras
U.S. Ser. No. 11/017,539B2—May 25, 2021—Object tracking and identification using intelligent camera orchestration
U.S. Ser. No. 10/999,566B1—May 4, 2021—Automated generation and presentation of textual descriptions of video content (Amazon Technologies, Inc.)
US20200364468A1—Nov. 19, 2020—Intelligent video surveillance system and method
U.S. Ser. No. 10/579,880B2—Mar. 3, 2020—Real-time object re-identification in a multi-camera system using edge computing
U.S. Pat. No. 9,134,399B2—Sep. 15, 2015—Attribute-based person tracking across multiple cameras
U.S. Pat. No. 8,866,910B1—Oct. 21, 2014—Unusual event detection in wide-angle video based on moving object trajectories
U.S. Pat. No. 8,564,661B2—Oct. 22, 2013—Video analytic rule detection system and method (Avigilon Analytics Corporation)
US20080018738A1—Jan. 24, 2008—Video analytics for retail business process monitoring
U.S. Pat. No. 5,835,667A—Nov. 10, 1998—Wactlar et al. —Method and apparatus for creating a searchable digital video library (Carnegie Mellon University)

### Foreign Patent Documents

CN120656102A—Sep. 16, 2025—Question and answer method, device, equipment and medium based on multi-fragment search (Ping An Technology Shenzhen Co Ltd)
CN120316308B—Sep. 9, 2025—Video retrieval generation method and device based on sparse representation and reordering (Harbin Institute of Technology)
AU2021218192B1—2021—Video anomaly detection method and system based on generative assistant discriminative network
WO2021137763A1—Jul. 8, 2021—Object re-identification using multiple cameras
CN110706259A—Jan. 17, 2020—A method and device for cross-camera tracking of suspicious persons based on spatial constraints
WO2016187648A1—Nov. 24, 2016—Retail customer analytic system
CN104094279A—Oct. 15, 2014—Cross-camera visual object re-identification method with wide range priority
WO2011022276A2—Feb. 24, 2011—Intra-trajectory anomaly detection using adaptive voting experts in a video surveillance system

### Other Publications

Academic Publications:—Luo et al. Video-RAG: Visually-aligned Retrieval-Augmented Long Video Comprehension (NeurIPS 2025)—Jeong et al. VideoRAG: Retrieval-Augmented Generation over Video Corpus (arXiv:2501.05874, January 2025)—Rosa, Kelvin Dela, Video Enriched Retrieval Augmented Generation Using Aligned Video Captions (arXiv:2405.17706, May 2024)—Arefeen et al. iRAG: An Incremental Retrieval Augmented Generation System for Videos (arXiv:2404.12309, May 2024)—Arefeen et al. ViTA: An Efficient Video-to-Text Algorithm using VLM for RAG-based Video Analysis System (CVPR 2024, NEC Labs)—Zanella et al. Harnessing Large Language Models for Training-free Video Anomaly Detection (CVPR 2024)

### SUMMARY OF THE INVENTION

The present invention provides a VideoRAG system architecture employing natural language text (not embeddings) as the intermediate representation layer between video content and retrieval systems. The architecture comprises three core modules plus two optional extensions (five modules total), implementing a novel two-layer logging architecture (sensory logs+entity trail logs) with event-driven selective capture that processes only meaningful events rather than all frames uniformly. A single vision-language model (VLM) with continuous batching serves multiple system modules, minimizing GPU requirements and system cost.
Module 1—Scene Sensing Module (SSM): A reasoning-capable Vision-Language Model (VLM) processes sampled video frames to detect meaningful motion and generate crude “sensory logs” describing scenes and detected moving entities in structured natural language format (e.g., person). The module employs adaptive frame sampling at domain-specific intervals and filters environmental motion. Disaster events (fire, smoke, flood) are immediately routed through emergency channels.
Module 2—Entity Trail Logger (ETL): A reasoning-capable VLM employing thought-tokens analyzes sensory logs from all cameras and optionally examines video clips to generate camera-unified “Entity Trail Logs” comprising clip-based temporal segments tracking individual entities from entry to exit. The module implements cross-camera entity tracking through attribute matching and routes suspicious activities to emergency channels. The ETL manages a dual-schema storage system: sensory logs stored as chronologically sorted JSONL files (24-72 hour retention, no indexing), and entity trail logs stored in a database with multi-level indexing including temporal B-tree index, entity-reference inverted index, and spatial index. Entity trail log entries undergo five-minute delayed index commitment after entity state stabilization.
Optional Module 3—Event Statistics Generator: An optional analytics extension that analyzes logs to generate aggregate event statistics (objects picked from location X: n times, number of people in area Y). This module accelerates business analytics queries by maintaining event counter logs for temporal pattern analysis.
Module 4—User-Facing Agent: A reasoning-capable VLM processes natural language queries, employs hybrid retrieval algorithms to search both sensory logs and entity trail logs, determines relevant video segments, and generates natural language responses with video timestamps and mandatory citations to source log entries. The agent implements text-based retrieval algorithms including sensory log sequential search, temporal range query on entity trail logs, and hybrid sparse-dense text retrieval combining BM25 sparse matching with sentence transformer dense reranking.
Optional Module 5—Emergency Channel: An optional responsive action extension that receives alerts from the Scene Sensing Module (disasters: fire, smoke, flood) and Entity Trail Logger (suspicious activities: theft, weapons, violence), classifies alert severity, and executes level-appropriate responsive actions including notifying security personnel or controlling door locks.

The system achieves technical improvements over prior art: 10-15× storage reduction through selective event capture vs. continuous frame embedding, <200 ms retrieval latency, human-readable text logs enabling direct SQL analytics, persistent entity trail logs tracking complete journeys vs. frame-level re-identification, and deployment flexibility through configurable schemas vs. model retraining.

### BRIEF DESCRIPTION OF THE DRAWINGS

FIG. 1—System architecture with unified VLM serving Scene Sensing Module, Entity Trail Logger, and User-facing Agent via continuous batching, plus optional Event Statistics Generator and Emergency Channel modules.

FIG. 2A—Scene Sensing Module processing pipeline: VLM generating crude entity descriptions, sensory log JSON output with disaster detection routing.

FIG. 2B—Entity Trail Logger processing pipeline: reasoning-capable VLM analyzing sensory logs with ReAct workflow, tracking entities across cameras, with delayed database commitment.

FIG. 3—Dual-schema storage architecture: sensory logs as chronologically sorted JSONL files; entity trail logs in PostgreSQL with multi-level indexing.

FIG. 4—User-facing Agent query processing: reasoning-capable VLM with hybrid retrieval, direct video analysis for verification, response generation with mandatory citations.

FIG. 5—Hardware deployment: consumer-grade computer with CPUs, GPUs, storage, running unified VLM with continuous batching.

FIG. 6—Sensory Log JSON Schema with timestamp, camera ID, motion/environmental/disaster flags, crude description field.

FIG. 7—Entity Trail Log JSON Schema with trail_id, entity_id, sensory_logs JSONB array, key_frame_embeddings, flags, temporal metadata.

### DETAILED DESCRIPTION OF THE INVENTION

### System Architecture Overview

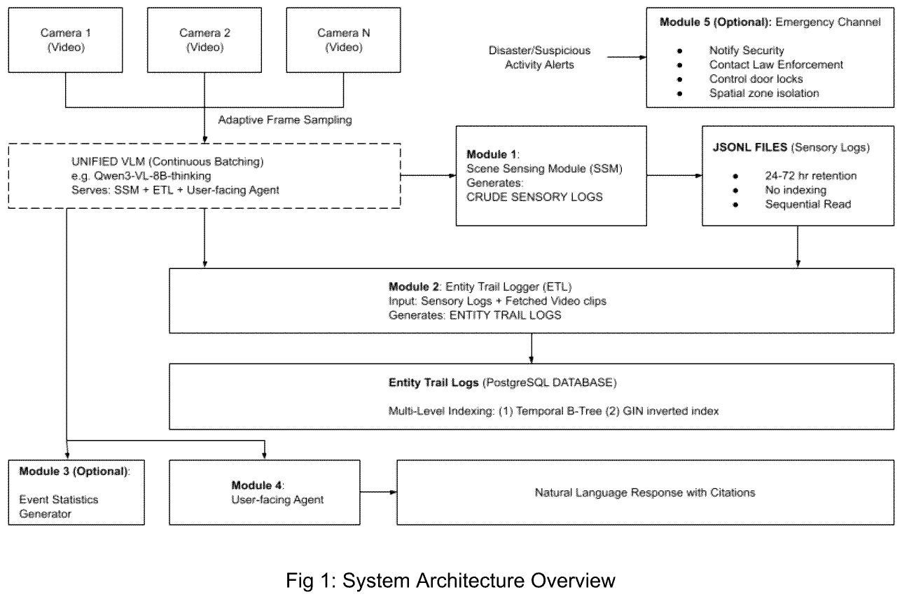

FIG. 1 illustrates the overall system architecture implementing a Natural Language Intermediate Representation Architecture comprising five modules: three core modules providing fundamental VideoRAG functionality, and two optional modules providing extended analytics and emergency response.

The system employs natural language text as intermediate representation between video content and retrieval systems through two levels:
Level 1—Sensory Logs (Crude Descriptions): The Scene Sensing Module analyzes video frames to generate frequent, low-level sensory logs describing detected entities in structured natural language format (e.g., person). Sensory logs capture meaningful motion while filtering environmental disturbances (curtains, shadows).
Level 2—Entity Trail Logs (Refined Descriptions): The Entity Trail Logger employs reasoning-capable vision-language models to analyze sensory logs, optionally examine selected video clips, and generate refined entity trail logs. Entity trail logs comprise clip-based temporal segments tracking individual entities across camera views with detailed natural language descriptions.
Video Input: The video input layer receives streaming video from one or more camera sources (N cameras, typical deployment: 1-10 cameras). Each camera produces video at frame rate F (15-30 fps typical). The system continually intakes frames at domain-specific intervals I (1-5 fps typical). In one embodiment motion-based adaptive sampling is used: if frame-to-frame optical flow magnitude exceeds threshold Tₘₒₜᵢₒₙ, sampling rate increases to I_{active}=5 fps; otherwise sampling rate decreases to I_{idle}=1 fps.
Unified Vision—Language Model Deployment: The system employs reasoning-capable vision-language model (VLM) at three key processing points: (1) Scene Sensing Module, (2) Entity Trail Logger, and (3) User-facing Agent. In one embodiment, the system utilizes an 8 billion parameter reasoning-capable VLM (e.g., Qwen3-VL-8B-Thinking). The same instance serves all modules through continuous batching infrastructure for efficient resource utilization. This unified architecture provides: (1) Cost Efficiency—deployment on consumer-grade GPUs (e.g., 2× NVIDIA RTX 4090, ˜$3,000 total) rather than datacenter-grade GPUs, (2) Resource Optimization—continuous batching enables dynamic request batching, (3) Deployment Simplicity—single inference server manages all VLM operations, (4) Concurrent Processing—the same VLM simultaneously processes video frames at 47×RTF while handling natural language queries.

### Module 1: Scene Sensing Module (SSM)

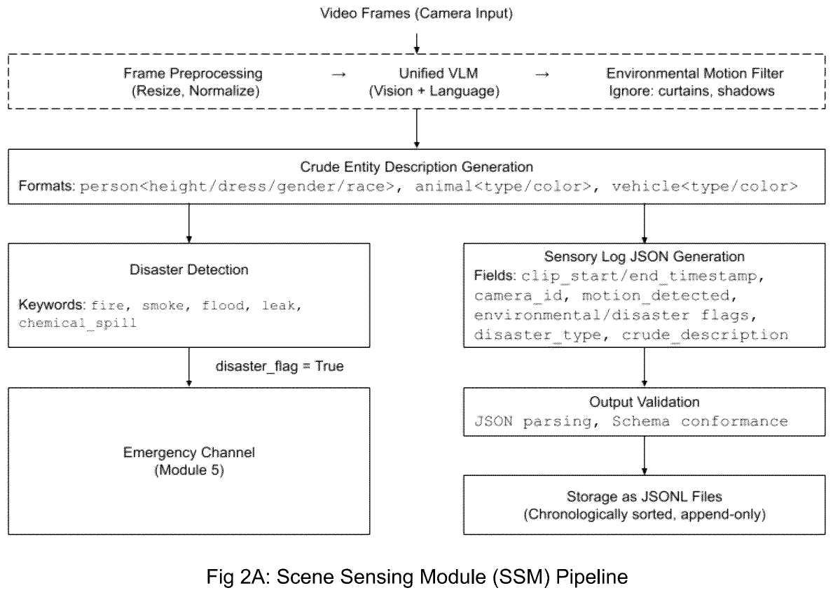

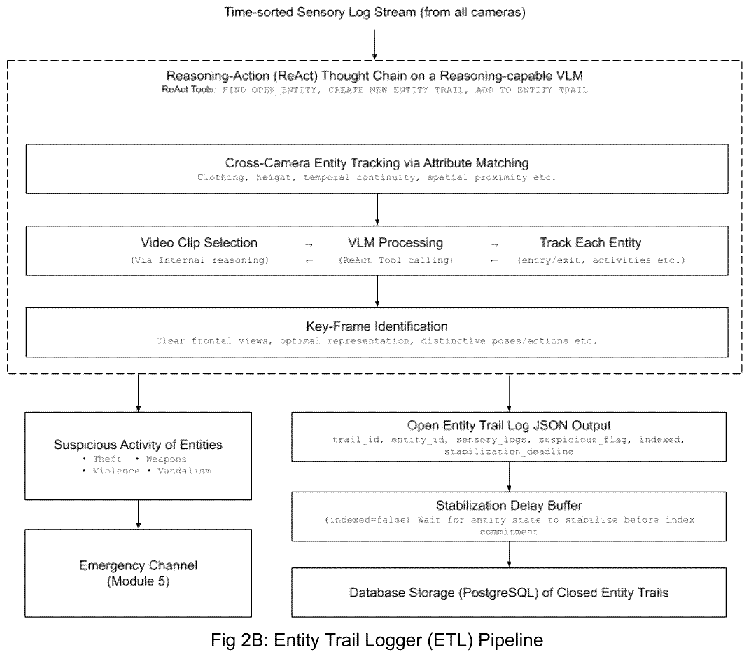

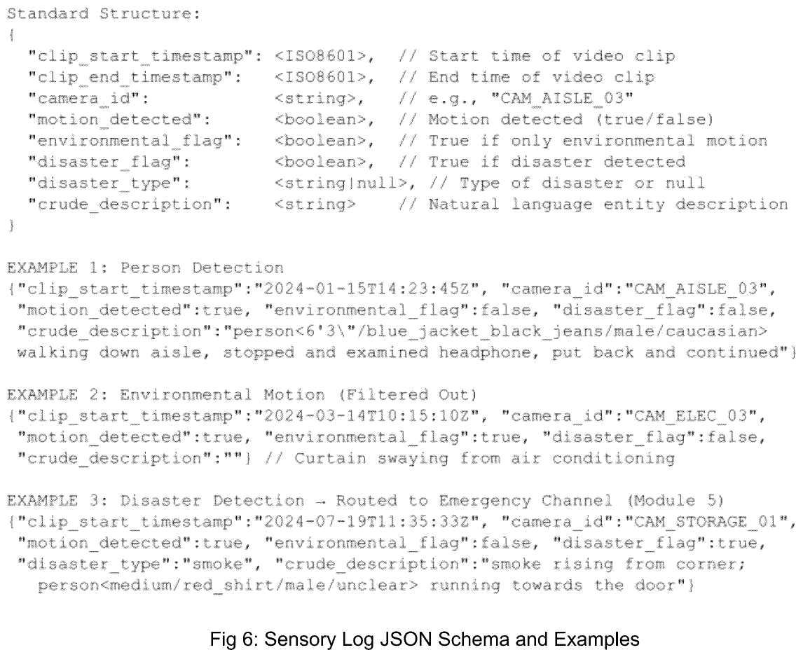

The SSM (see FIG. 2A) processes sampled video frames to detect meaningful motion events and generate crude sensory logs describing moving entities in structured natural language format. The module filters environmental motion (curtains, shadows) to process only frames containing substantive events, and routes disaster alerts (fire, smoke, flood) to the Emergency Channel.
Frame Preprocessing: Input frames undergo preprocessing: resize to VLM input dimensions (e.g., 384×384), normalization to [0,1] range, optional region-of-interest cropping if domain-specific focus areas are defined.
VLM Processing for Sensory Log Generation: Preprocessed frames are processed by a VLM that handles vision encoding, vision-language alignment, and language generation in an integrated pipeline. The VLM receives system prompts instructing it to: generate crude entity descriptions in structured format (entity_type), filter environmental motion, detect disasters using keywords (fire, smoke, flood, water leak, sparks, chemical_spill), include camera context, and output JSON format with fields: clip_start_timestamp, clip_end_timestamp, camera_id, motion_detected, environmental_flag, disaster flag, disaster type, crude_description.
Concrete Example—Sensory Log Output (see FIG. 6): Scenario: Retail store, tall male customer in blue jacket examining electronics.

```
{
  “clip_start_timestamp”: “2024-01-15T14:23:45Z”,
  “clip_end_timestamp”: “2024-01-15T14:28:11Z”,
  “camera_id”: “CAM_AISLE_03”,
  “motion_detected”: true,
  “environmental_flag”: false,
  “disaster_flag”: false,
  “crude_description”: “A person<6′3\″/blue_jacket_black_jeans/male/caucasian>
walking down aisle three. Stopped briefly at 2024-01-15T14:24:27Z for holding and
examining a headphone. Put the headphone back and continued walking at
2024-01-15T14:27:04Z.”
}
```

Output Validation and Emergency Routing: Generated sensory logs undergo validation: JSON parsing verification, schema conformance checking, temporal consistency checking, crude description format verification. Invalid outputs trigger regeneration. In one embodiment, validation achieves 94-97% first-pass success rate. If disaster flag=true, the entry is immediately routed to the Emergency Channel with high priority.
Performance Characteristics: The SSM achieves faster-than-real-time processing. In one embodiment: complete VLM inference 15-25 ms per frame, output validation 1-2 ms, total per-frame latency 20-30 ms, real-time factor approximately 47× (processes 5 minutes of video in 6 seconds). Sensory logs generated: 0.01-3 logs per second per camera, sensory log storage: ˜0.1-2 KB per log entry.

### Module 2: Entity Trail Logger (ETL)

The Entity Trail Logger (see FIG. 2B) analyzes sensory logs generated by all SSMs using a reasoning-capable VLM to produce refined “Entity Trail Logs” tracking individual entities across the monitored area. The module employs thought tokens (internal reasoning mechanisms) to select relevant video clips for detailed examination, generates clip-based temporal segments with key frame identification, implements cross-camera entity tracking, manages dual-schema storage for both sensory and entity trail logs, and routes suspicious activity alerts to the Emergency Channel.

VLM Processing with Reasoning

The ETL continuously monitors the streams of sensory logs generated by all SSMs. A reasoning-capable VLM (e.g., Qwen3-VL-8B-Thinking) analyzes sensory log sequences to identify patterns requiring detailed video examination. Example Reasoning Process: The VLM receives time-sorted sensory log sequences from multiple cameras:

T=14:23:10, CAM_AISLE_03, crude_description:
“Person<tall/blue_jacket_black_jeans/male/caucasian> walking down electronics aisle,
browsing shelves.”
T=14:23:45, CAM_AISLE_03, crude_description:
“Person<tall/blue_jacket_black_jeans/male/caucasian> stopped at display shelf, picking up
smartphone device.”
T=14:27:05, CAM_AISLE_04, crude_description: “Person<tall/blue_jacket/male/caucasian>
walking through aisle 4, heading toward checkout.”

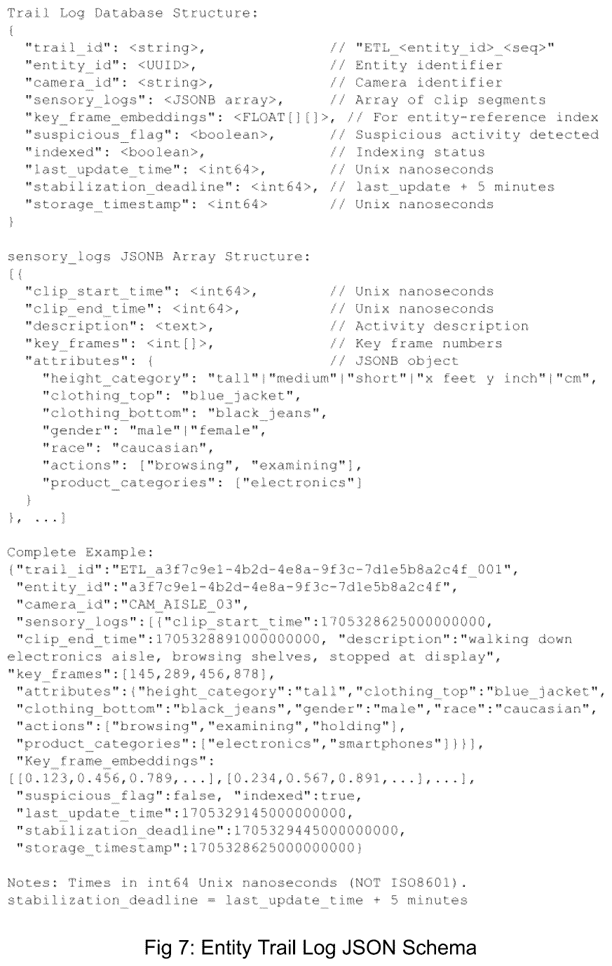

The VLM analyzes sensory log attributes (clothing, height, camera, activity) and executes tool calls: FIND_OPEN_ENTITY to check existing trails, CREATE_NEW_ENTITY_TRAIL for new entities, ADD_TO_ENTITY_TRAIL for matching entities, with key frame updates when better visibility is available (frontal face>side view).
Output Entity Trail Logs (see FIG. 7 for complete schema): Example for entity P_001:

```
{
  “trail_id”: “ETL_P_001_046”,
  “entity_id”: “P_001”,
  “camera_id”: “CAM_AISLE_03”,
  “clip_start_time”: “2024-01-15T14:23:45Z”,
  “clip_end_time”: “2024-01-15T14:23:50Z”,
  “description”: “stopped at display shelf, picking up smartphone device”,
  “key_frame”: {“frame_number”: 878, “timestamp”: “2024-01-15T14:24:32Z”},
  “attributes”: {“height_category”: “tall”, “clothing_top”: “blue_jacket”,
“clothing_bottom”: “black_jeans”, “gender”: “male”, “race”: “caucasian”}
}
```

VLM System Prompt: The Entity Trail Logger VLM operates under a system prompt specifying: track entities across cameras using temporal and spatial continuity; generate entity trail logs via tool calling (FIND_OPEN_ENTITY, CREATE_NEW_ENTITY_TRAIL, ADD_TO_ENTITY_TRAIL); select optimal key frames for entity identification; minimize tool calls through description matching when attributes are unambiguous. Available tools include FIND_OPEN_ENTITY (check if entity matches existing open trails), CREATE_NEW_ENTITY_TRAIL (create new trail), and ADD_TO_ENTITY_TRAIL (add sensory log to existing trail).
Suspicious Activity Detection and Emergency Routing: The ETL analyzes entity trail logs to detect suspicious activities. Detection employs pattern matching on activity descriptions using domain-specific keywords: theft-related (“exits without paying”, “concealed item”), weapon-related (“holding gun”, “brandishing knife”), nuisance-related (“pet urinating”, “vandalism”), loitering (“standing still>20 minutes”). When suspicious_flag=true, entity trail logs are immediately routed to Emergency Channel with priority based on severity: High (weapon-related, theft in progress), Medium (completed theft), Low (nuisance activities). Emergency routing occurs in real-time (<100 ms latency).

### Storage and Indexing

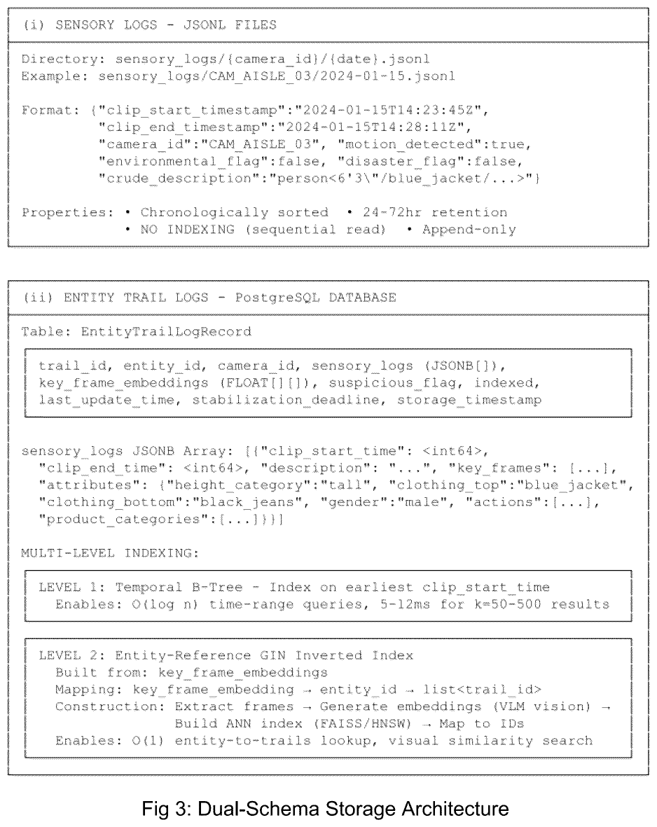

The Entity Trail Logger manages a dual-storage system with different storage strategies optimized for each log type:
Storage Format 1—Sensory Log Records: Sensory logs are stored as chronologically sorted JSONL (newline-delimited JSON) entries in append-only files. Files organized by camera_id and date (e.g., sensory_logs/CAM_AISLE_03/2024-01-15.jsonl). Storage characteristics: fast sequential writes, efficient chronological scanning for ETL processing, no indexing required, per-log size ˜0.5-2 KB, retention 24-72 hours typical.
Storage Format 2—Entity Trail Log Records: Entity trail logs (closed/stabilized trails only) are stored in a database with rich schema supporting complex queries and long-term retention (see FIG. 3). Schema includes: trail_id, entity_id, sensory_logs JSONB array (containing clip_start_time, clip_end_time, description, key frames, attributes), key_frame_embeddings for similarity search, suspicious_flag, indexed, last_update_time, stabilization_deadline, storage_timestamp.
Multi-Level Indexing Architecture (Closed Trails Only): Only stabilized entity trail logs are indexed. Active trails remain unindexed until stabilization deadline. Index Level 1—Temporal B-Tree: B-tree index on earliest clip_start_time within sensory_logs array enables O(log n) time-range queries. For n=5 million closed logs (30 days×10 cameras), tree height=3 levels, range query complexity=O(3+k) where k is result count. Index Level 2—Entity-Reference Inverted Index: Maps entity_id→list enabling O(1) entity lookup, generated using key frame visual embeddings indexed via ANN (FAISS/HNSW).
Storage Efficiency Analysis: Dual-schema architecture achieves substantial storage reduction versus embedding-based systems. Sensory logs: ˜0.5-4 GB (24-72 hour retention), entity trail logs: ˜26-78 GB (30-day retention), total 30-day storage: 30-80 GB. Comparison: Dense embeddings (768-dim float32, continuous): 155 GB for 30 days. Natural Language Intermediate Representation Architecture achieves 2-5× storage reduction, and including text compression efficiency versus embeddings, overall system achieves 10-15× storage reduction.

### Delayed Index Commitment (5-Minute Stabilization)

The Entity Trail Logger implements intelligent delayed indexing to prevent premature indexing of incomplete entity trails. When an entity is actively moving through the surveillance area, their trail log entries are continuously updated as new clips are generated.
5-Minute Stabilization Algorithm: When a new entity trail log entry is created or updated, set: indexed=false, last_update_time=current_time, stabilization_deadline=current_time+5 minutes. Background stabilization checker runs every 30 seconds. For each entry where stabilization_deadline has been reached: check if entity has been updated recently; if last_update_time+5 minutes<current_time, entity is “stabilized”; if stabilized: add entry to temporal B-tree index and entity-reference inverted index, set indexed=true; if not stabilized: extend stabilization_deadline by 5 additional minutes.
Rationale: The 5-minute delay ensures entity trail logs are indexed only after the entity has stopped moving/changing for 5 consecutive minutes, preventing: premature indexing of partial entity trails, frequent index updates, and index fragmentation.

### Module 3: Event Statistics Generator (Optional)

This optional analytics module aggregates entity trail logs into statistical summaries for business intelligence and operational insights. Not required for core VideoRAG functionality.
Functionality: extracts event types from entity trail logs (product_pickup, customer entry, dwell_time); aggregates counts by event type, location zone, and time window (hourly, daily, weekly); stores in EventCounterRecord schema with temporal indexes. Supports queries like “How many customers picked up smartphones in electronics aisle between Jan 1-7?” Schema: EventCounterRecord {counter_id, event type, location filter, time_window_start, time_window_end, time_window_granularity, count, last_updated}.

### Module 4: User-Facing Agent

The User-facing Agent processes natural language queries from end users, searches both sensory logs and entity trail logs using hybrid retrieval algorithms, determines relevant video segments, and generates natural language responses with mandatory citations to source events and video timestamps. The module employs reasoning capabilities (thought tokens) to analyze query intent and strategically search both log types.

### Text-Based Retrieval Algorithms

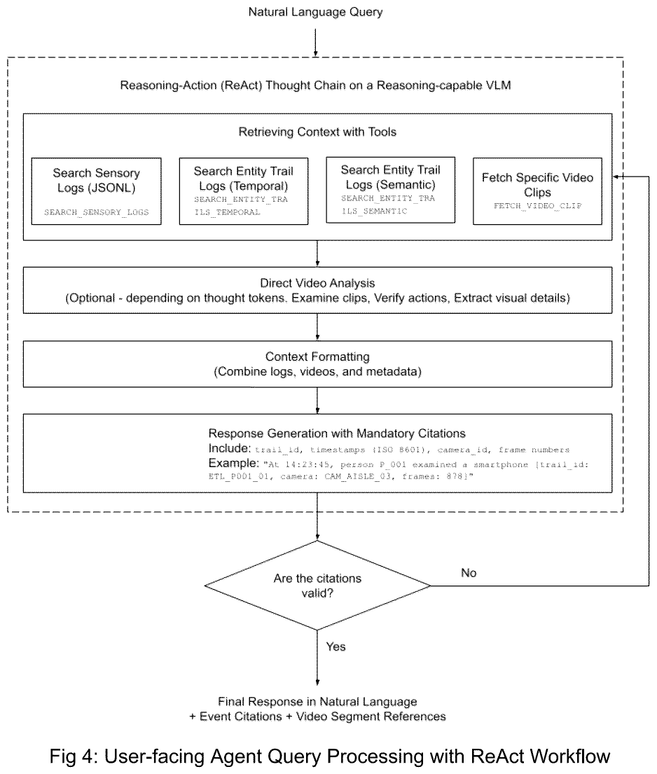

The retrieval subsystem implements algorithms for searching natural language descriptions in sensory logs (JSONL files) and entity trail logs (indexed database), operating on text rather than embeddings.
Algorithm 4.1—Sensory Log Sequential Search: For very recent queries (<5 minutes ago, before entity trails are stabilized and indexed), the system searches sensory logs stored as chronologically sorted JSONL files. Query: “What happened in the last 3 minutes?” Algorithm: (1) Determine time range: [current_time—3 min, current_time], (2) Identify relevant JSONL files based on date and cameras, (3) Read files sequentially from end, parse each JSON line until clip_start_timestamp<time_range_start, filter matching entries, (4) Merge results from all cameras, sort by timestamp. Complexity: O(m) where m=entries in time range. Typical performance: 10-25 ms for 3-minute window.
Algorithm 4.2—Temporal Range Query on Entity Trail Logs: For historical queries (>5 minutes ago), the system queries closed/indexed entity trail logs from the database. Query: “All trails involving entity #P_47 between 14:00 and 16:00 on 2025-01-15”. Algorithm: (1) Parse temporal range: [t start, t_end], (2) B-tree range query on earliest clip_start_time→trail_ids in range (O(log n+k)), (3) Filter by entity_id using GIN inverted index (O(k)), (4) Retrieve full EntityTrailLogRecord for each trail_id. Complexity: O(log n+k) where k=result count, n=total indexed entity trail logs. Typical performance: 15-40 ms for k=50-500 results.
Algorithm 4.3—Hybrid Sparse-Dense Text Retrieval: For natural language queries without explicit temporal or entity constraints, the system employs hybrid retrieval combining lexical matching and semantic understanding. Query: “Show me instances where someone examined a product for a long time then returned it”. Stage 1—Query Analysis: Extract key terms, identify implicit constraints. Stage 2—Sparse Retrieval (BM25): Full-text index on sensory_logs[ ]. description field, execute BM25 search with k_1=1.5, b=0.75, retrieve top N candidates (N=100-200 typical). Stage 3—Dense Reranking: Encode query with sentence transformer, encode concatenated descriptions, compute cosine similarity, rerank candidates. Stage 4—Temporal Clustering: Group retrieved trails by entity_id, identify temporal sequences matching query pattern. Return top K entity trail sequences (K=10-20 typical).
   Query Processing with Reasoning (see FIG. 4)

The query processing subsystem employs a reasoning-capable VLM to process natural language queries, invoke retrieval tools (implementing Algorithms 4.1-4.3), directly analyze video clips using vision capabilities, and generate natural language responses with mandatory citations.
Query Processing with ReAct Reasoning: The VLM employs a ReAct (Reasoning+Acting) workflow, alternating between thought tokens (internal reasoning), retrieval tool calls, and video analysis using vision capabilities.
User Query: “I'm missing three bottles of Jack Daniels. Show me everyone in the whiskey aisle yesterday between 2-4 pm.”

<thought>
Theft investigation query with temporal constraint (yesterday 2-4pm) and location
(whiskey aisle). Historical query requiring entity trail logs. Need detailed visual
evidence of interactions with whiskey bottles to identify suspicious behavior patterns
like concealment.
</thought>
TOOLCALL(“SEARCH_ENTITY_TRAILS_TEMPORAL”, [time_range=[2024-01-15T14:00:00Z,
2024-01-15T16:00:00Z], camera_ids=[“CAM_AISLE_04”], filters={“location”:
“whiskey_aisle”}])
<thought>
Retrieved 7 entity trail logs. Trail ETL_P_12445_003 description mentions “handling
whiskey bottles” at 15:23-15:27. Text description insufficient for theft determination.
Need to view actual video clip to analyze body language, concealment behavior, and verify
checkout compliance.
</thought>
TOOLCALL(“FETCH_VIDEO_CLIP”, [trail_id=“ETL_P_12445_003”, camera_id=“CAM_AISLE_04”,
start_time=2024-01-15T15:23:15Z, end_time=2024-01-15T15:27:42Z])
<thought>
Viewing 4-minute video clip. Vision analysis reveals: At 15:26:18 (frame 1847), person
lifts Jack Daniels 750ml bottle and conceals it inside hoodie - clear concealment motion
visible. Person repeatedly glances toward checkout area (15:24-15:26), then exits aisle
without approaching checkout. Cross-referencing trail data: person exited main entrance
at 15:29:03 without checkout interaction. Strong theft indicator.
</thought>

Tool-Based Retrieval Architecture: Algorithms 4.1-4.3 are exposed to the VLM as callable tools:
Tool 1: SEARCH_SENSORY_LOGS(time_range, camera_ids, filters)—Purpose: Sequential search of recent sensory logs (<5 minutes ago) per Algorithm 4.1.
Tool 2: SEARCH_ENTITY_TRAILS_TEMPORAL(time_range, entity_id, camera_ids, filters)—Purpose: B-tree indexed search of historical entity trails (>5 minutes ago) per Algorithm 4.2.
Tool 3: SEARCH_ENTITY_TRAILS_SEMANTIC(query, max_results, filters)—Purpose: Hybrid BM25+semantic retrieval for natural language queries per Algorithm 4.3.
Tool 4: FETCH_VIDEO_CLIP(trail_id, camera_id, start_time, end_time)—Purpose: Retrieve video clip for VLM visual analysis to verify behavior.
System Prompt: The User-facing Agent VLM operates under ReAct workflow with tool access. Available tools as described above. Workflow: Analyze query→Select tool→TOOLCALL→Analyze results→FETCH_VIDEO_CLIP if verification needed→Generate response. Response requirements: cite specific trail IDs, timestamps, camera IDs, frame numbers for all claims; ground in retrieved logs only (no parametric knowledge); express uncertainty explicitly if evidence insufficient.
VLM Processing Pipeline: Stage 1—Query Understanding (Reasoning Phase): The VLM analyzes the query using 468<thought> tags per ReAct workflow: temporal analysis, entity analysis, location analysis, log type selection, recency check. Stage 2—Tool Invocation and Video Analysis (Acting Phase): Based on reasoning, the VLM invokes appropriate retrieval tools, analyzes retrieved trails, fetches video clips for visual verification when investigating suspicious behavior. Stage 3—Response Generation: The VLM generates responses with mandatory constraints: citation requirement (every claim must reference specific trail IDs or timestamps), grounding constraint (responses derive only from retrieved context), uncertainty expression.

### Example Response—Theft Investigation Query:

Query: “I'm missing three bottles of Jack Daniels from inventory. Show me everyone who
was in the whiskey aisle yesterday afternoon between 2-4pm.”
Response:
I found 7 individuals who interacted with the whiskey aisle between 2024-01-15T14:00:00Z
and 2024-01-15T16:00:00Z. Two instances show suspicious behavior warranting
investigation.
Suspicious Activity:

| | |
|---|---|
| • | Trail ETL_P_12445_003: Male in black hoodie |
| | Evidence: CAM_AISLE_04 [2024-01-15T15:23:15Z - 2024-01-15T15:27:42Z] |
| | Description: Person repeatedly glanced toward checkout area while handling whiskey |

bottles, eventually concealed Jack Daniels bottle (750ml) inside hoodie at
2024-01-15T15:26:18Z. Left aisle without proceeding to checkout.

Analysis: Concealment behavior combined with surveillance checking strongly indicates

theft. Entity trail shows person exited main entrance at 2024-01-15T15:29:03Z without
passing through checkout zone.
Normal Browsing Activity (5 individuals):

| | |
|---|---|
| • | Trail ETL_P_11203_012: Examined bottles, purchased (verified via checkout trail) |
| • | Trail ETL_P_11678_019: Brief browsing, no purchase |
| • | Trail ETL_P_12001_004: Store employee restocking shelves |
| • | Trail ETL_P_13445_002: Examined bottles with companion, both purchased |
| • | Trail ETL_P_14112_001: Retrieved single bottle, proceeded directly to checkout |

Confidence: High - All 7 individuals have complete entity trail coverage with clear video
evidence from whiskey aisle cameras.

Hallucination Prevention Mechanisms: (1) Prompt Engineering: System prompt explicitly prohibits using parametric knowledge beyond retrieved logs, (2) Citation Verification: Post-processing validates that all cited trail IDs/timestamps exist in retrieved context, (3) Confidence Scoring: VLM outputs confidence scores—High (>0.85): multiple corroborating trails; Medium (0.6-0.85): partial evidence; Low (<0.6): sparse evidence.
Performance Characteristics: VLM query processing benchmarks (in one embodiment using 8B parameter model): query understanding latency 50-120 ms, response generation latency 300-800 ms, total end-to-end query latency: retrieval (15-62 ms)+VLM processing (350-920 ms)=365-982 ms, end-to-end system RTF: 3-7× for typical queries, citation accuracy: 96.8%, hallucination rate: 2.1%.

### Module 5: Emergency Channel (Optional)

Optional module receiving alerts from SSM (disasters: fire, smoke, flood, chemical spills) and ETL (suspicious activities: theft, weapons, violence, vandalism), classifying severity, and executing responsive actions. Not required for core VideoRAG functionality.
Severity Levels and Response Times: CRITICAL (weapons/fire, <30 s response)→HIGH (theft/spills, <2 min)→MEDIUM (completed theft, <10 min)→LOW (loitering, <30 min). Actions: emergency contact, zone lock/unlock, video forwarding, dashboard alerts, personnel notification. Schema: EmergencyEventRecord {event_id, alert source, alert_type, alert_timestamp, severity, actions_executed, action_timestamps, personnel_notified, video_references, resolution status}.

### System Integration and Deployment

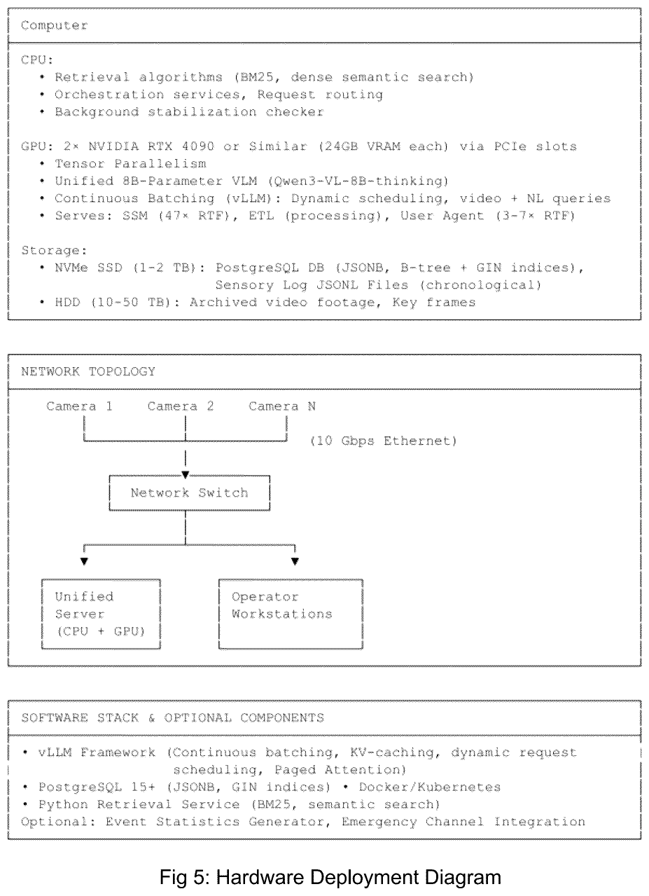

### Hardware Configuration (see FIG. 5)

Typical deployment for 10-camera surveillance system: GPU server: 2× consumer-grade GPUs (e.g., NVIDIA RTX 4090, 24 GB each) configured with tensor parallelism for unified VLM inference; CPU server: 2× Intel Xeon or AMD EPYC (32-64 cores) for retrieval and orchestration; Storage: 1-2 TB NVMe SSD for databases and logs, 10-50 TB HDD for archived video; Network: 10 Gbps connection for camera streams.

### Software Stack

Unified VLM inference: vLLM framework with continuous batching for dual-purpose inference (video processing and query handling), with tensor parallelism across plurality of consumer-grade GPUs; Database: PostgreSQL 15+ with JSONB and B-tree indexing; Retrieval: Custom Python service implementing Algorithms 4.1-4.3; Orchestration: Docker containers with Kubernetes for scaling.

### Continuous Batching Architecture

The system employs vLLM framework's continuous batching capability, enabling a single VLM to serve dual purposes simultaneously. In one embodiment using an 8B parameter VLM: (1) Video Frame Processing: processes sampled frames at 47× real-time for visual scene analysis, (2) Natural Language Query Processing: handles user queries with 3-7× end-to-end RTF for typical queries. Continuous batching allows requests from both pipelines to be dynamically batched together, maximizing GPU utilization without requiring separate model instances. This approach provides: resource efficiency (single model instance serves both video and query workloads), dynamic load balancing, reduced memory footprint, simplified deployment.

1. A computer-implemented method for video retrieval augmented generation using natural language intermediate representation, comprising:
(a) Scene Sensing Module—Processing sampled video frames to:
(i) detect meaningful motion events while filtering environmental motion comprising at least curtain movements and shadow movements,
(ii) generate sensory logs comprising crude entity descriptions in structured natural language format, wherein said crude entity descriptions follow a pattern entity_type, and
(iii) route disaster alerts comprising at least fire, smoke, or flood detections to an alert pathway;
(b) Entity Trail Logger—Employing a reasoning-capable vision-language model to:
(i) analyze said sensory logs using thought tokens comprising internal reasoning mechanisms to select relevant video clips for detailed examination,
(ii) generate entity trail logs comprising clip-based temporal segments, wherein each entity trail log entry specifies: an entity identifier, a camera identifier, a clip start time, a clip end time, and a natural language description of entity activities within said temporal segment,
(iii) identify key frames within each clip-based temporal segment where entities are most identifiable,
(iv) track entities across multiple camera views by computing weighted attribute correlation scores between entities appearing in different cameras, wherein said weighted correlation comprises clothing attribute similarity, height similarity, and temporal proximity,
(v) store both sensory logs and entity trail logs in a dual-schema storage architecture, wherein sensory logs are stored in chronologically-sorted files for sequential access and entity trail logs are stored in a database indexed using a temporal B-tree index and an entity-reference inverted index generated from said key frames, and
(vi) delay indexing of entity trail log entries until entity state remains unchanged for a predetermined stabilization duration, preventing premature indexing of incomplete entity trails;
(c) User-facing Agent—Processing natural language queries to:
(i) employ thought tokens comprising internal reasoning mechanisms to analyze query intent and determine which log types to search,
(ii) retrieve relevant log entries from said sensory logs and said entity trail logs using hybrid sparse-dense text matching algorithms comprising BM25 for sparse lexical matching and sentence embeddings for dense semantic matching,
(iii) determine relevant video segments based on retrieved log entries, and
(iv) generate natural language responses with mandatory citations to source events and video timestamps, wherein said responses are derived exclusively from said retrieved log entries.

2. The method of claim 1, wherein said vision-language model processing pipeline achieves real-time or faster-than-real-time processing for video frame analysis while concurrently handling natural language queries.

2a. The method of claim 1, wherein said vision-language model processing for scene sensing, entity trail logging, and query processing is performed by a single unified vision-language model instance configured with continuous batching to enable concurrent processing of video frames and natural language queries, thereby minimizing graphics processing unit requirements and wherein said continuous batching mechanism dynamically batches requests from video frame processing and natural language query processing pipelines with efficient utilization of available processing resources.

2b. The method of claim 1, wherein said vision-language model employs parallelization techniques to distribute model computation across plurality of graphics processing units, enabling efficient deployment on commodity hardware.

3. The method of claim 1, wherein said storing of natural language descriptions results in a storage consumption rate of approximately 200 to 500 bytes per described event, achieving a compression ratio of at least 10:1 compared to storing dense vector embeddings for an equivalent duration of video surveillance.

4. The method of claim 1, wherein said adaptive sampling logic increases the sampling rate to approximately 5 frames per second when an optical flow magnitude exceeds a motion threshold and decreases the sampling rate to approximately 1 frame per second when said magnitude falls below said threshold.

5. The method of claim 1, wherein said hybrid retrieval mechanism comprises: (a) a sparse retrieval stage utilizing a BM25 algorithm to identify initial candidate records; followed by (b) a dense reranking stage utilizing sentence transformer embeddings to reorder said candidate records based on semantic similarity to the user query; wherein said hybrid mechanism achieves higher normalized discounted cumulative gain (NDCG) scores than sparse-only or dense-only retrieval methods.

6. The method of claim 1, wherein said domain-specific schema defines attributes for person detection including at least a height value or category enumerated as short, medium, or tall, and clothing color/attribute categories utilizing a standardized color palette.

7. The method of claim 1, wherein said vision-language model in query processing mode is configured with a system prompt explicitly prohibiting the use of parametric knowledge not present in the retrieved log records (sensory logs or entity trail logs), and wherein said method further comprises a validation step to verify that every citation in the generated response corresponds to a valid trail identifier or log timestamp in the retrieved context.

8. The method of claim 1, further comprising a validation pipeline for the generated natural language descriptions that: (a) verifies conformance to said domain-specific schema; (b) checks for temporal consistency between the description timestamp and video frame timestamp; and (c) triggers a regeneration of the description with error-feedback prompting if validation fails.

9. The method of claim 1, wherein said predetermined stabilization duration is a predetermined amount of time, wherein entity trail log entries are indexed only after the entity state remains unchanged for said predetermined amount of time.

9a. The method of claim 1, further comprising an Event Statistics Generator module that: (a) analyzes said sensory logs and said entity trail logs to generate event count statistics over specified time ranges, (b) maintains an event counter log tracking occurrence frequencies of specific event types, and (c) provides a query interface for retrieving aggregated event counts grouped by time windows and locations.

9b. The method of claim 1, further comprising an Emergency Channel module that: (a) receives disaster alerts from said Scene Sensing Module and suspicious activity alerts from said Entity Trail Logger, (b) classifies alerts into severity levels comprising at least CRITICAL, HIGH, MEDIUM, and LOW priorities, and (c) executes responsive actions based on said severity levels, wherein said responsive actions comprise at least one of: notifying security personnel, contacting law enforcement, controlling door locks, or isolating spatial zones.

9c. The method of claim 9b, wherein said responsive actions for CRITICAL severity alerts comprise sending live video feeds from relevant cameras to security personnel and triggering automated notifications to emergency services within 30 seconds of alert generation.

10. A video retrieval augmented generation apparatus implementing natural language intermediate representation architecture, comprising:
(a) Scene sensing processor configured to:
(i) process sampled video frames to detect meaningful motion events while filtering environmental motion,
(ii) generate sensory logs comprising crude entity descriptions in structured natural language format, and
(iii) route disaster alerts to an alert pathway;
(b) Entity trail logger processor with reasoning capabilities, configured to:
(i) analyze said sensory logs using thought tokens to select relevant video clips,
(ii) generate entity trail logs comprising clip-based temporal segments with entity identifiers, camera identifiers, clip start times, clip end times, and natural language activity descriptions,
(iii) identify key frames where entities are most identifiable,
(iv) track entities across cameras using weighted attribute correlation,
(v) implement a dual-schema storage architecture storing sensory logs in chronologically-sorted files for sequential access and entity trail logs in a database with temporal B-tree indexing and entity-reference inverted index generated from key frames, and
(vi) implement a delayed indexing mechanism that indexes entity trail log entries only after entity state remains unchanged for a predetermined stabilization duration;
(c) User-facing agent processor with reasoning capabilities, configured to:
(i) employ thought tokens to analyze query intent and determine log types to search,
(ii) implement a hybrid retrieval subsystem performing sparse lexical matching using BM25 and dense semantic matching using sentence embeddings on said sensory logs and said entity trail logs,
(iii) determine relevant video segments based on retrieved logs, and
(iv) generate natural language responses with mandatory citations to source events and video timestamps.

11. The apparatus of claim 10, wherein said vision-language inference processor comprises one or more graphics processing units (GPUs), and wherein said apparatus is configured to process video from one of more camera sources while simultaneously handling natural language queries.

12. The apparatus of claim 10, wherein each stored text record in said database comprises a unique event identifier, a timestamp, a camera identifier, and a JSON-formatted description string containing the structured natural language description.

13. The apparatus of claim 10, wherein said database utilizes a B-tree index for temporal range queries and an inverted index for entity identifier lookups, enabling retrieval complexity of O(log n) for temporal queries.

14a. The apparatus of claim 10, further comprising an event statistics processor configured to: (a) analyze said sensory logs and said entity trail logs to generate event count statistics, (b) maintain an event counter log, and (c) provide aggregated event counts grouped by time windows and locations.

14b. The apparatus of claim 10, further comprising an emergency channel interface configured to: (a) receive disaster alerts from said scene sensing processor and suspicious activity alerts from said entity trail logger processor, (b) classify alerts into severity levels, and (c) execute responsive actions comprising at least notification of security personnel, contact of law enforcement, or control of door locks.

15. The method of claim 1, applied to a retail environment, wherein said domain-specific schema comprises event types for product interactions and checkout events, and wherein said retrieval mechanism is configured to support analytical queries regarding customer dwell time and conversion rates.

16. The method of claim 1, further comprising a real-time alerting process that evaluates newly generated text descriptions against a set of predefined rule patterns and transmits a notification to an operator interface when a description matches a critical safety or security rule.

17. The apparatus of claim 10, wherein said entity tracking processor is configured to track entities across adjacent cameras by maintaining higher correlation scores for entities appearing in temporally proximate cameras within a predetermined time gap, thereby enabling continuous entity tracking across multiple camera views.
